(19) United States
(12) Patent Application Publication
(10) Pub. No.: US 2010/0292931 A1
(43) Pub. Date: Nov. 18, 2010

(54) OPTICAL PLATFORM FOR SIMULTANEOUSLY STIMULATING, MANIPULATING, AND PROBING MULTIPLE LIVING CELLS IN COMPLEX BIOLOGICAL SYSTEMS

(75) Inventors: Sheng Wang, Albany, CA (US); Cheng Sun, Wilmette, IL (US); Xiang Zhang, Alamo, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 12/774,856

(22) Filed: May 6, 2010

Related U.S. Application Data
(63) Continuation of application No. PCT/US2008/082897, filed on Nov. 7, 2008.
(60) Provisional application No. 60/986,956, filed on Nov. 9, 2007.
(60) Provisional application No. 61/015,235, filed on Dec. 20, 2007.

(51) Int. Cl. G06F 19/00; G01N 21/00

(52) U.S. Cl. 702/19

(57) ABSTRACT

An optical platform and system for the simultaneous stimulation, manipulation and probing of multiple living cells in complex biological systems. The apparatus utilizes a spatiotemporal light modulator to expose a sample to pinpoints of light at selected times and wavelengths in two or three dimensional space and then detect the responses. In one embodiment, a spatiotemporal light modulator is optically coupled to a variable wavelength light source, a lens system and a system control unit with sample response sensors, wherein sample responses are detected after exposure to patterns of light in real time. Light patterns can be modulated in response to sample responses.

### CROSS-REFERENCE TO RELATED APPLICATIONS

This application claims priority from, and is a 35 U.S.C. §111(a) continuation of, PCT international application number PCT/US2008/082897 filed on Nov. 7, 2008, incorporated herein by reference in its entirety, which claims priority from U.S. provisional application Ser. No. 60/986,956 filed on Nov. 9, 2007, incorporated herein by reference in its entirety, and from U.S. provisional application Ser. No. 61/015,235 filed on Dec. 20, 2007 incorporated herein by reference in its entirety.

This application is also related to PCT International Publication No. WO 2009/062107 published on May 14, 2009, incorporated herein by reference in its entirety.

### STATEMENT REGARDING FEDERALLY SPONSORED RESEARCH OR DEVELOPMENT

This invention was made with Government support under Grant No. DMI-0327077 awarded by NSF and Grant No. NCC 2-1364 awarded by the NASA Center for Cell Mimetic Space Exploration (CMISE). The Government has certain rights in this invention.

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to diagnostic imaging and optical screening, and more particularly to optical systems and methods for simultaneously stimulating, manipulating and probing cells in complex biological systems.

2. Description of Related Art

One difficulty encountered in the study or treatment of complex intercellular biological systems is the absence of effective tools for spatiotemporal control and detection of biological activity in a large number of associated cells. The activity of the system of connected cells and the functional connections between cells and groups of cells in response to stimuli cannot be readily observed by present analytical techniques.

For example, the human brain is an organized, interconnected network of more than 100 billion nerve cells. It is the interconnections between nerve cells and the collective cellular activities that underlie perception, thought, decision-making and action. A primary challenge in neuroscience is to understand how groups of cells communicate and dynamically regulate their connections in the massive neural networks of the brain. Accordingly, there is a need for tools that permit the organized activation and monitoring of activity in groups of cells that represent discrete components of larger networks.

Several devices have been developed and perfected over the last few decades that attempt to quantify neuron activity. Patch clamps, for example, have been a useful tool for accurately stimulating and recording electrical activity in neurons. However, the use of patch clamps requires a high degree of skill and it is difficult to scale up to using more than a few patch clamps at a time because each neuron requires its own clamp for stimulation.

Micro-fabricated arrays of electrodes, or Field Effect Transistors (FET), have been used for parallel stimulation and recording. However, these methods cannot control the activity in selected target cells within the densely packed tissue of neural circuits. As a result, most experimental research still focuses on the function of one or a few neurons or synapses. In addition, the established methods for electrical stimulation and recording are invasive, and involve the direct contact of devices with neurons.

Accordingly, there is a need for a system and method for the simultaneous, sequential and selective stimulation of cells in a network that is not invasive and is adaptable to computer automation. The present invention satisfies this need as well as others and is generally an improvement over the art.

### BRIEF SUMMARY OF THE INVENTION

The present invention is an apparatus and system for the study of complex biological systems such as neural networks using light sensitive activity indicators and micro-scale precision illumination to stimulate, inhibit and record activity within a network in two or three dimensions. Sequence, time and space of the activity of cells or groups of cells within a biological network can be identified and pieces of the system can be selectively activated or inactivated with specific illuminations of light of varying wavelengths. Parallel activations of cells or groups of cells in different parts of the network can also be accomplished and will permit investigation and control of higher level biological system functions. The controller provides multiple selective cellular stimulation patterns that can be applied according to position in three dimensional space, sequence or time durations etc. Patterned excitations and dynamic responses provide real time control or analysis of the optically sensitive biological network.

Accordingly, an aspect of the invention is a novel optical platform for simultaneously stimulating, manipulating, and probing multiple living cells in complex biological systems. In one embodiment, the invention comprises at least one light source having an output; a spatiotemporal light modulator optically coupled to the output of the light source; a system control unit operatively coupled to the light sources and the light modulator that has an output configured for optical coupling to a lens system. The lens system is configured for directing modulated light from the light source and the light modulator to a sample. The system control unit is configured for acquiring and processing sample information in response to exposure of the sample to the modulated light.

In various embodiments, the lens system comprises a microscope or projection lens or an objective lens.

In other embodiments, the light source is selected from the group consisting of one or more of a light emitting device such as a lamp, a light emitting diode, a halogen lamp, a mercury lamp, a xenon lamp, an LED or LED array of any available wavelength, and a laser of any available wavelength.

In various embodiments, the spatiotemporal light modulator may be selected from the group consisting of one or more of a shutter, mechanical shutter, electronic shutter, liquid crystal shutter, a chopper, a rotation wheel, an electric pulse power source, an Acousto-Optic Modulator, an Electo-Optic Modulator, a digital mirror device, a liquid crystal display, and scanning mirrors with shutters or choppers.

In one embodiment, a wavelength modulator is integrated with the spatiotemporal light modulator. In various embodiments, the wavelength modulator may be selected from the group consisting of one or more filters at various wavelength bands, a plurality of different color light emitting diodes, and a plurality of different color lasers.

In another embodiment, an optical pathway from the light source to the spatiotemporal light modulator is provided. In a further embodiment, an optical pathway from the lens system to the sample is provided.

In some embodiments, the system control unit is configured to capture signals from the sample, analyze the captured signals, generate pattern serials for spatiotemporal modulation, and to control spatiotemporal and wavelength modulated pattern serials that are directed to the sample.

In various embodiments, the captured signals are selected from the group consisting of one or more optical signals, electrical signals, topological signals, thermal signals, chemical signals, fluorescence signals, images of single frames or frame serials, spectrum, light intensity, polarity, lifetime, intensity, Fluorescence Resonance Energy Transfer, ion concentrations (such as calcium indicators) or membrane potentials (such as voltage sensitive dyes). The signals may also be the presence of certain proteins, cells, biological activity information from organs, membrane potentials or current information through single or multiple electrodes from individual cells or groups of cells, biological sample height, shape, configurations or connections, temperature distribution among the sample, chemical compounds or their structure, conformation changes, chemical reactions, and pH values.

Electrical signals can also be measured and collected from the biological samples, and can include the membrane potentials or information on currents through single or multiple electrodes from individual cells or group of cells. Electrodes can be patch clamps, intracellular electrodes, extracellular electrodes, FET (field effect transistors), electrode or FET arrays, or transparent electrodes (array), such as the ITO (Indium-Tin-Oxide) electrode (array) etc.

Topological signals can be biological sample height, shape, structural configurations or connections, etc., and can be detected through AFM (atomic force microscope), optical methods, etc.

Thermal signals can include temperature distribution along the sample that can be detected through various means such as thermometers, thermocouples, irradiation spectrum information or images etc.

Chemical signals such as chemical compounds or their structure, conformation changes, occurrence of specific chemical reactions, pH values, etc. can be converted and detected through optical or electrical signals by many different types of sensors or meters.

The system control unit can control the acquisition of data signals from physical detectors or from commercial software which controls the physical detectors. The control unit can control signal data acquisition from human commands, trigger inputs, or through certain algorithms.

In various embodiments, sample information is selected from the group consisting of one or more of optical responses, health, applicability, conformation, morphology, connection, position or motion of the sample, optical or electrical information, recognition, trace, analysis or prediction of sample morphology, shape, configuration, position or motion, comparison, calculation or analysis of fluorescence signals, comparison, calculation or analysis of electrical signals.

In some embodiments, various components and/or instruments (e.g., electrodes, patch clamp, ITO electrode array, AFM etc.) which can acquire or detect such signals can be integrated into the system.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic of one embodiment of the apparatus of the invention.

FIG. 2 is a schematic view of one embodiment of the invention configured for spatiotemporal control of the activity of cells expressing optically sensitive ion channels and detecting intracellular calcium concentration in order to report cellular activity.

FIG. 3A is a schematic representation of a cell membrane with optically sensitive ion channels in the “off” position.

FIG. 3B is a schematic representation of a cell membrane with optically sensitive ion channels in the “on” position.

### DETAILED DESCRIPTION OF THE INVENTION

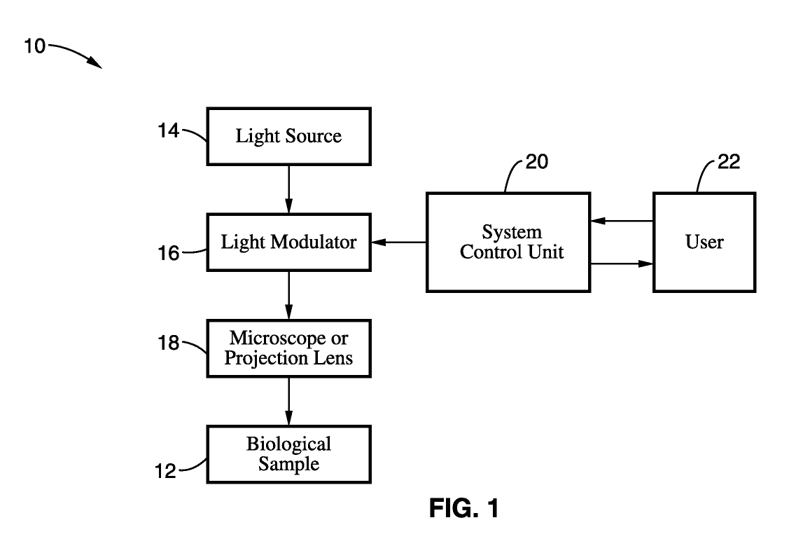

Referring more specifically to the drawings, for illustrative purposes the present invention is embodied in the apparatus generally shown in FIG. 1 through FIG. 3B. It will be appreciated that the apparatus may vary as to configuration and as to details of the parts, and that the methods may vary as to the specific steps and sequence, without departing from the basic concepts as disclosed herein.

The optical platform of the present invention takes advantage of natural or artificial light sensitive elements in cells of a network and also indicators of specific activity of the cell or groups of cells in the biological network. Optical activation or inhibition of light sensitive elements of cells or groups of cells may be achieved with exposure to different wavelengths of light and with controlled, selective exposures to one or more parts of the network.

Turning now to FIG. 1 and FIG. 2 through FIG. 3B, the apparatus 10 of two embodiments of the invention are schematically shown. One preferred embodiment is configured to be coupled to a conventional microscope and to use the optics of the microscope. In an alternative embodiment, the apparatus can be designed with specially configured optical pathways and image recording capabilities. The apparatus 10 shown schematically in FIG. 1, generally comprises an observation platform to allow the observation and illumination of a biological sample 12 with a light source 14, a spatiotemporal light modulator 16, a microscope or projection lens or objective lens 18 and a system control unit 20. The user interface 22 preferably includes a view screen, keyboard and data storage and recording functions.

In FIG. 1, a biological sample 12 is obtained for study. The apparatus and methods of the invention 10 can be applied to many different types of biological systems and subsystems including molecules, microorganisms, single cells, groups of cells, parts of organs, whole organs, in vivo animal models or human bodies that have activity that is optically sensitive or can be made to be optically sensitive. The optical responses indicating activity can be a native property of the sample or optically sensitive indicators such as chemical compounds, molecules, or proteins etc. that are introduced to the sample.

The optical biological effects of the samples 12 that are applied by parallel and spatiotemporal modulated light may include: (a) stimulation or inhibition of cells (i.e. neurons etc) through a variety of ion channels or gates or receptors on a cell membrane; (b) bioactivity control through triggering receptors (for example GPCRs (G-Protein-Coupled Receptors) etc.); activating or deactivating proteins or RNAs or genes within cell signal pathways; (c) trapping, stretching or manipulating cells or part of the cells by optical or optoelectronic forces; (d) heating the samples through optical thermal effects to interfere with the bioactivities of the cells or to kill the cells; (e) controlling transportation, translocation, differentiation, migration, growth, polarization formation or growth of the cells by activating, deactivating or trapping intracellular factors or extracellular factors or cells themselves; (f) controlling diffusion, transportation or translocations of certain molecules, proteins, DNA, RNA, receptors, growth factors or regulation factors within different parts or domains of one cell (for example, transportation or translocations between cell membranes, nuclear membranes, soma, dendrites or axons of the neuron and diffusion within cell membranes or inside of the cells); and (g) controlling or manipulating communications or information exchanges among cells, (for example activating or deactivating morphogens, growth factors or neurotransmitters, controlling release or secretion or reception of a morphogen, growth factors or neurotransmitters).

The system 10 can be configured to spatiotemporally modulate, stimulate, control, manipulate, trap or probe multiple domains of the cell or multiple cells within the sample in parallel, depending on the type of responses that are made by the sample. In the case of neurons, the sample can be cultured neurons, brain slices, cerebral cortex studies or in vivo animal studies. Although neural networks are used as an example, it will be understood that the apparatus and methods can be adapted for use in many different biological systems.

For neural network analysis or control, different types of natural or artificial optically sensitive ion channels or other types of photo-sensitive elements can be exploited or introduced into the neuron cells for optical manipulation. Ion channels within cell membranes have been shown to be activated or inhibited by a number of different stimuli including voltage, protein ligands, light and temperature. The photosensitive ion channels can be created through chemical alteration to be optically sensitive or may be naturally occurring light sensitive channels or membrane proteins. For example, Rhodopsins, Channelrhodopsin-2 (ChR2), Halorhodopsins, (NpHR), Volvox Channelrhpdopsin-1 (VChR1), light-activated ionotropic glutamate receptor (LiGluR) and light activated potassium channels have been used to make neurons and other cells optically sensitive. One or more of these types of photosensitive membrane proteins can be introduced or exploited in neurons or other cell samples.

Biological networks, such as neural networks, can also be stimulated or inhibited by the light actuated release of caged neurotransmitters, calcium or drugs. Neuron cell activity can also be monitored by voltage sensitive dyes or dyes sensitive to environmental changes that can be converted to optical signals of cell activity. Neural cell differentiation, polarization formation, migration, growth guidance and manipulation can be achieved by (a) optically activating or deactivating neurotransmitters or neurotrophins etc. (b) optical control of the secretion or reception of neurotransmitters or neurotrophins etc., and (c) mechanical stretching or trapping, parallel optical trapping methods by multiple-beam optical tweezers or dielectrophoresis (DEP). Trapping by optoelectronic tweezers (OET) can also be employed.

The light source 14 of FIG. 1, preferably provides light at the selected wavelengths and intensities to activate or deactivate the light sensitive components in the sample as well as to illuminate the sample for observation and image recordation. Light source 14 can be selected for multiple photon activation processes if necessary, such as for the purposes of deeper light penetration or higher spatial resolution. Light source 14 can include multiple sources that are activated simultaneously or sequentially.

The light source 14 can be a lamp, an LED (light emitting diode), a laser, etc., or various combinations of light sources. Examples of preferred lamps include, but are not limited to, halogen, mercury, xenon or different combinations of lamps. The LED light source 14 can be a type selected from any or all available wavelengths. It will be appreciated that the LED is preferably a high-power density device. The light intensity from the LED that is applied to the sample can normally be tuned by its power supply or controller and up to a maximum output. The laser light source can be of a type that produces light at available characteristic wavelengths for single photon or multiple photon activation.

If necessary, temporal and wavelength modulation can be utilized for each light source choice or combination of sources in order to meet the need for stimulating, regulating and manipulating the biological sample. For example, temporal modulation can be achieved by shutters (e.g., mechanical, electronic, LC (liquid crystal) types, etc.) or choppers (e.g., rotation wheels) with the use of lamps.

When using LED's, temporal modulation of the light source 14 can be achieved by applying electric pulse power or shutters or choppers. Electrical pulse power can be produced, for example, by the use of a specific circuit board, commercialized LED driver or with a controller. Temporal resolution as a function of the modulator is preferably approximately one millisecond or higher. For example, low temporal resolution modulation (e.g., approx. 100 milliseconds or longer) can be produced with a combination of a power supply and a simple relay with computer controlled trigger inputs. For high temporal resolution modulation (e.g. from less than one microsecond to 100 milliseconds), an LED controller can be used. When using low intensity lasers, temporal modulation can be achieved by AOM's (Acousto-Optic Modulator), or EOM (Electro-Optic Modulator) or shutters or choppers.

Wavelength (color) modulation of light source 14 can be achieved with lamps with filters at various wavelength bands (e.g., UV (ultraviolet), all visible colors, IR (infrared)). When using LED's, wavelength (color) modulation can also be achieved by integrating different colored LED's into the system (additional filters might be applied to make specific wavelength bands that meet the strict requirements of biological activity indicators or actuators). When using lasers, wavelength (color) modulation can also be achieved by integrating different colored lasers into the system.

Both temporal and wavelength modulation can be provided by combinations of different light sources 14 in various ways. For example, light modulation can include the use of (a) rotation wheels with different wavelength (color) filters at different sections (may or may not be combined with shutters); (b) lamps with different wavelength (color) fixed filters that are combined with shutters or choppers that project to the same work area on the sample; (c) different wavelength LED's (with or without additional filters) integrated with an LED controller circuit board to supply pulse power; (d) different wavelength LED's (with or without additional filters) integrated with shutters or choppers; (e) different wavelength Lasers integrated with AOM's; and (f) different wavelength Lasers integrated with shutters or choppers.

For the light source 14, multiple reflection or transmission lenses can also be added to collect light from light source 14 more efficiently and to make the light beam collimated. Also multiple lenses can be added to expand or reduce the light beam to meet the requirements of the spatiotemporal light modulator 16.

Additionally, wavelength modulation of the light source 14 can optionally be used. If wavelength modulation is used, it can be implemented using multiple light sources 14 where each light source has its specific wavelength. Another approach uses a single light source with different wavelength filters on a rotation wheel or translocation slider.

If multiple light sources 14 are integrated into the system where each light source has a specific wavelength, the different wavelength light sources can be coupled by dichroic or non-dichroic beam splitters, mirrors or prisms, and the light can then be routed to the same spatiotemporal light modulator 16. Another embodiment would configure the system so that each different wavelength light source 14 shines on a different spatiotemporal light modulator 16, and the light would then be coupled by dichroic or nondichroic beam splitters, mirrors or prisms to the same working area.

If a single light source 14 is used along with different wavelength filters on a rotation wheel or translocation slider, the filters can be positioned anywhere in the optical pathway between the light source 14, modulator 16 and the sample 12.

The spatiotemporal light modulator 16 element of FIG. 1 is configured to generate the dynamic spatiotemporal illumination patterns that are to be focused onto the biological sample 12. The illumination patterns are preferably generated by the system control unit 20 based on information obtained from the specific sample. Patterns of light that are applied to the sample 12 may be general or may be specific pinpoint illuminations of a cell or parts of a cell in two-dimensional (2D) or three-dimensional (3D) space. The illumination patterns may also be based on sample information obtained iteratively during the procedure. Therefore, functionally or structurally interconnected cells can be simultaneously illuminated or sequentially illuminated and the activity of groups of cells can be identified or controlled. Likewise, a series of connected cells or groups of connected cells can be stimulated in parallel and subsequently observed.

Examples of light modulators 16 include a DMD (Digital Mirror Device), an LCD (Liquid Crystal Display), an AOM (Acousto-Optic Modulator) or Scanning mirrors with shutters or choppers. A DMD, for example, is a digital mirror array that consists of 800,000 micromirrors that are controllable and provide very small points of light. DMD's and LCD's achieve parallel operation (spatiotemporal light modulation) by a control unit 20. AOM's and Scanning mirrors with shutters or choppers can have fast light point position or scanning control in one or two dimensions to achieve spatiotemporal light modulation.

The light source 14 and light modulator 16 are preferably controlled by the system control unit 20 from programming as well as input decisions and data from the user interface 22. Therefore, light of a designated wavelength and intensity can be applied to specific locations on a sample 12 with a desired spot shape and size and at a desired time and sequence.

Projection of the light points or areas of illumination and the acquisition of sample images is preferably accomplished with the use of projection or objective lenses 18 or through the optics of a microscope. In one embodiment, the invention is adapted to couple to a commercially available microscope. In that embodiment, the system comprises a light source 14, a spatiotemporal light modulator 16, and system control unit 20 that are sized to fit as an attachment to the microscope and to use the existing optical pathway configuration of the microscope.

In this embodiment, the light directed into the optics 18 of the microscope will project a spatiotemporal modulated pattern on to the sample 12. Objective lenses with different zoom in or zoom out magnifications and N.A. (Numerical Apertures) can be used and sized to accommodate the varying dimensions of the samples 12.

The light 14 and light modulator 16 can be coupled into the microscope objective lenses 18 through various microscope input ports (e.g., camera ports, lamp ports, specially designed filter wheel or slider ports or any other ports which can couple light into the optical pathway of the microscope), in this embodiment.

In an alternative embodiment, the projection lenses or objective lenses 18 are components of the system itself. Here, the system 10 comprises a light source 14, a spatiotemporal light modulator 16, a projection lens or objective lens module 18, and a system control unit 20 with a designed optical pathway configuration. In an alternative specifically designed optical pathway, light from the spatiotemporal modulator 16 will be projected through the projection lens or objective lens 18 that is located outside of the microscope body to the sample 12.

Additional optical components, a charged coupled device (CCD) or other image recorder, and optical pathway design may be added to achieve specific desired functions similar or beyond that of the commercial microscope. Such components can be functionally coupled to the system control unit 20 and to a user interface and recording devices 22.

Normally, light from source 14 will be projected into the microscope, projection lens or objective lens 18 after spatiotemporal modulation 16 and then to the sample 12. However, in one embodiment, optional filters, dichroic or nondichroic beam splitters, mirrors or prisms, lens, or more spatiotemporal light modulators to couple or integrate the light can be inserted into the optical pathway.

In another embodiment, there can be additional temporal modulation other than spatiotemporal light modulation 16. If there is both temporal modulation and wavelength modulation of light 14 by the system control unit 20, temporal modulation for different wavelengths of light can be correlated or synchronized to any desired time delay. Such synchronization can be achieved, for example, by controlling a pulse power supply, rotation or translocation filters, shutters, choppers, AOM's, EOM's to the light sources. While not critical, temporal modulation is preferably included in the system.

Referring specifically to FIG. 1, the system control unit 20 is preferably a computing device that performs control, analysis and recording functions for the apparatus 10. The control unit 20 can be adapted to receive information from outside sources and have sensors to facilitate the function of the components and system.

The primary functions of the system control unit 20 (including hardware and software) include: (a) capturing the signals from the sample; (b) analyzing the sample information; (c) generating pattern serials for spatiotemporal modulation through certain predetermined or real time algorithms or human machine interactions, and (d) controlling spatiotemporal and wavelength modulated serial patterns shinning on the sample.

(a) Capture of signals from the sample: The cellular activity signals obtained from sample 12 after exposure to modulated light 16 can be collected by the system control unit 20 of the invention or collected by commercial software that interfaces and communicates with the system control unit 20 or from sensors. The signals from biological samples 12 can be optical, electrical, topological, thermal, chemical, etc.

Optical signals, for example, can be fluorescence or other types of activity indicators. Images of single frames or frame serials, spectrum, light intensity, polarity, lifetime, etc. can be, for example, sample responses to the illumination of a sample 12 to a spatiotemporal light pattern from the light modulator 16. Fluorescence signals can be intensity, lifetime, FRET (Fluorescence Resonance Energy Transfer) signals, etc. Fluorescence signals can reflect biological activity information such as ion concentrations (such as calcium indicators), membrane potentials (such as voltage sensitive dyes) or other the activity or the presence of proteins, cells, or organs.

Electrical signals can also be measured and collected from the biological samples 12 from various sensors. For example, electrical signals can be obtained representing membrane potentials or currents through single or multiple electrodes from individual cells or groups of cells and the like. Electrodes can be patch clamps, intracellular electrodes, extracellular electrodes, FET (field effect transistors), electrode or FET arrays, or transparent electrode (arrays), such as the ITO (Indium-Tin-Oxide) electrode (array) etc.

Similarly, topological signals can include biological sample height, shape, configurations or connections, etc., and can be detected through AFM (atomic force microscope), or through optical methods, etc.

Thermal signals can determine the temperature distribution at different points in the sample. Thermal signals can be detected through various thermometers, thermocouples, irradiation spectrum information or images etc.

Chemical signals such as chemical compounds or their structure, conformation changes, specific chemical reactions, pH values, etc. can be converted and detected through optical or electric signals by many different types of sensors or meters.

Accordingly, the system control unit 20 can control the acquisition of data signals from physical detectors or from commercial software which controls the physical detectors. The control unit 20 can control signal data acquisition from human commands, trigger inputs, or through appropriate algorithms and programming.

(b) Analysis of the Sample Information: Sample information analysis can be conducted through predetermined programming or by real time algorithms or human-machine interactions. Sample information can include optical responses, health applicability, conformation, morphology, connection, position or motion of the sample etc. Sample information can be optical or electrical signals or collections of signals. Sample information can be based on real time sample responses to spatiotemporal modulated light or can include previously obtained sensor data.

Processing of sample information will be influenced by the type of biological system that is being studied and the activity indicators that are selected and the sensors that are used. Analysis of sample information can include analysis algorithms such as (a) recognition, trace, analysis or prediction of sample morphology, shape, connection, configuration, position or motion; (b) comparison, calculation or analysis of fluorescence signals; (c) comparison, calculation or analysis of electrical signals or other signals as described previously.

Sample information can also include human-machine interactions to determine the exposure parameters including the location of exposure or response locations in three-dimensional space as well as the sequence of the light exposures. Human selection of the light exposures can also override the programming in one embodiment. Human judgment or analysis can be communicated with the computer through a human-machine interaction interface 22 of the hardware and software of the system control unit 20.

Accordingly, there is significant variability in the nature of the samples, biological activities as well as the selection of spot size, wavelength, intensity and duration of applied light that can be used with the apparatus.

(c) Generation of Sample Illumination Patterns:

Pattern generation of the illumination points on the sample is preferably based on the acquired sample information that is initially gathered and analyzed. Illumination patterns can have variable spot sizes, shapes, wavelengths, intensities, times and sequences. In one embodiment, the patterns are generated from sample information obtained from imaged frames to provide the location and time parameters for illumination. Pattern serials generated by the control unit 20 can be single or multiple frames in one embodiment. Pattern generation can also be through predetermined or real time algorithms or with human-machine interactions.

Pattern generation algorithms can be derived through random processes or according to set rules or purposes depending on the components of the biological system under study. Algorithm rules may be based on biological mechanisms, research of the sample components, communications within a neural circuit, control information flow in neural circuit, or training neural circuit connections to realize a specific configuration or function.

Pattern generation can also include human-machine interactions where illumination points are implemented by the judgment or the analysis of human users. Human judgment or analysis can be communicated with the computer through human-machine interaction interface 22 of the system control unit 20.

(d) Control of spatiotemporal and wavelength modulated pattern serials that are directed on the sample: The system control unit 20 controls the spatiotemporal light modulator 16 and correlates or synchronizes with any additional temporal and wavelength modulation to the light source 14 to make desired spatiotemporal and wavelength modulated pattern serials that are directed on the sample 12 over time.

In one embodiment, control of the spatiotemporal light modulator 16 is realized by controlling the pattern serials (pre-generated or generated in real time from the control unit) that are displayed by the light modulator 16. The speed or frequency of the display of patterns on the light modulator 16 can be controlled and up to the maximum capacity of the spatiotemporal light modulator. The patterns represent the spatial modulation and serials of patterns displayed continuously or with desired intervals to produce the final spatiotemporal modulation.

In another embodiment, control of the additional temporal and wavelength modulation to the light source 14 can be achieved by controlling different combinations of temporal modulations and wavelength modulations through the system control unit 20. For example, the pulse power supply to different wavelength light sources (such as LED's etc) can be synchronized to any desired delay within the capability of the selected light modulator 16, typically approximately a millisecond.

Similarly, AOM's or EOM's of different wavelength light sources (such as Lasers etc.) can be controlled and synchronized to any desired delay preferably up to approximately a millisecond or as high a resolution as the modulator can provide. Delays can also be created in other embodiments by controlling the rotation of filter wheels or filter slider translocation which is located between the light source (such as lamps etc) and samples and synchronizing them to any desired delay. Accordingly, the control of the spatiotemporal modulator 16 and the additional temporal and wavelength modulation to a light source can be correlated or synchronized by the control unit 20 to any desired delay.

It can be seen that the system control unit 20 can include many different functions, sensors and system components. Versions of the system can also have components that produce redundant modulation functions etc. There can be synchronization among different functions of the components in real time. For example, the system 10 can capture a sample signal and then control the spatiotemporal and wavelength modulated pattern serials that are directed to the sample which can be synchronized to a desired delay. Between the delays, the sample information can be analyzed and a new pattern can be generated in real time by certain algorithms or by human-machine interaction.

In another example, the software of the control unit 20 can perform the sample analysis and pattern generation offline. After generation, the capture of sample signal and control of the spatiotemporal and wavelength modulated pattern serials (based on pre-generated patterns) shining on the sample can be synchronized to a desired delay. It will be appreciated, therefore, that an embodiment of the inventive system can be a continuous, closed-loop system and may integrate artificial intelligence algorithms.

e) Detection and Analysis

Detection of the effects of the spatiotemporal light pattern shining on a sample can be achieved electrically or optically or through biochemical or molecular biological analysis. The results of each illumination event can be recorded and analyzed by the system control unit 20 and subsequently displayed. Programming can model the results of the sequence of sample responses to the illumination events in two or three dimensions or graph, tabulate or otherwise display the results. New patterns can be generated that account for the results of previous illumination events.

If the detection of sample activity is implemented optically, it can occur through the same projection or objective lens or through an additional detector device. Detection can optionally take place through the microscope. Examples of optical detectors include, but are not limited to, a CCD (charge-coupled device) camera, a PMT (Photo Multiplier Tube), a PMT array, a photo diode, a photo diode array, a spectrometer etc., all of which are commercially available devices.

Within the optical pathway between the sample and the optical detector, there optionally can be inserted filters, dichroic or nondichroic beam splitters, mirrors or prisms, lens, or additional spatiotemporal light modulators to couple the light to optimize the optical image.

In one embodiment, the system comprises two color LED's (with collimated lens and filters), coupled through dichroic beam splitters to one DMD, then after another additional lens, the light is projected through the objective lens within a microscope on to the sample. In one embodiment, additional temporal modulation to the LED's is achieved by sending a software controlled trigger signal to each LED controller, and then the pulse power is supplied by each LED controller according to the trigger signal. In one embodiment, optical detection is achieved through the microscope (through the same objective lens that the spatiotemporal light is projected into).

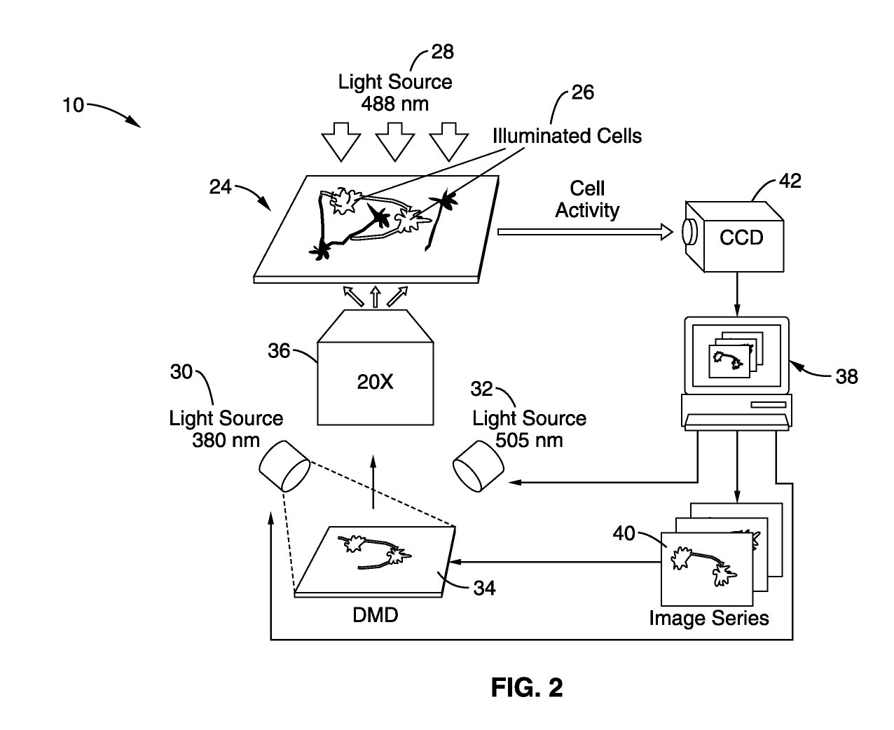

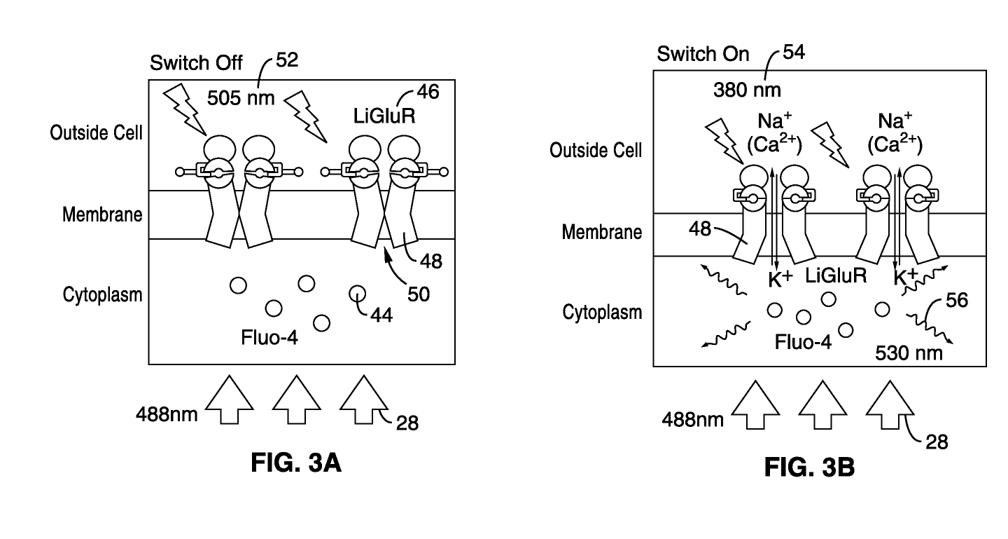

Turning now to FIG. 2 and FIG. 3A and FIG. 3B, one embodiment of the system 10 is provided that is configured for the detection of nerve cell activity in a nervous system tissue sample. A biological sample 24 of a network of nerve cells is provided for manipulation and analysis. In this embodiment, the neurons of the sample have ion channels that are modified to provide a selective light activated or deactivated switch with the exposure to specific wavelengths of light as seen in FIG. 3A and FIG. 3B. This is an optical method that will allow the stimulation of many neurons simultaneously or sequentially and to identify the neural connections.

The system 10 of the embodiment shown schematically in FIG. 2 has a prepared sample 24 that is on a specimen platform associated with a digital mirror device (DMD) 34 that can project spatially designed patterns of points of light directly or through an objective lens 36 to selected cells 26 within the field over a designated time frame. Predetermined indicators of cellular activity and the location of the sample cells 26 are observed with a camera 42 or other suitable detector. Cellular activity is monitored over time and in response to specific patterns of exposure to points of light at selected wavelengths. The location and stimulation of cells within a sample network can be charted or mapped in two or three dimensions. Series of images can be created and recorded over time.

A system controller 38 records and analyzes the location of the indicators of cellular activity in the sample. The system controller also controls the light exposures from general light source 28 for viewing the structure and locations of the individual sample as well as controlling one or more specific frequency light sources 30 and 32 that are configured to stimulate or quench cellular activity through photo sensitive switches. Light sensitive proteins or caged proteins or compounds can be activated or deactivated at multiple cell sites at the same time or sequentially and in parallel through the pinpoint exposures with the digital mirror device 34. Programming in the system controller 38 can modulate the illumination of specific cells with points or shape of light at selected frequencies based on the acquired size and location data of cells on a micron scale and on a millisecond time scale.

Referring also to FIG. 3A and FIG. 3B, one type of light activated chemical switch is shown to illustrate the type of control that can be used with the system 10. FIG. 3A and FIG. 3B depict schematically a cross section of a cell membrane with two ion channels 48 that are in the closed and open positions respectively. The channels 48 are activated or deactivated by exposure to light of different wavelengths. The ion channel 48, in the case of a neuron, opens to permit the exchange of calcium ions, sodium ions and potassium ions across the membrane when the neuron is stimulated. A fluorescent dye (Flou-4) 44, that reports the concentration of calcium ions, is used as an indicator of activity and will cause the stimulated cells to change in fluorescence intensity, which can be registered optically by a digital camera 42.

The chemical switch embodiment in this illustration is a light-activated ionotropic glutamate receptor (LiGluR) in the form of a modified ionotropic glutamate receptor conjugated with a glutamate based chemical photoswitch that can be activated with 380 nm light and deactivated with 505 nm light. A tether molecule 46 contains a light sensitive component such as azobenzene that changes trans/cis conformations when exposed to the different wavelengths of light. When the photo-switch is exposed to the 380 nm wavelength light 54, the azobenzene changes conformation allowing the glutamate molecule to bind to the receptor and the ion channel 48 opens triggering the neuron and the flow of ions as shown in FIG. 3B.

When the switch is exposed to 505 nm light 52 the tether molecule 46 changes to a different conformation and the glutamate is pulled out of the binding site and the ion channel is closed stopping the flow of ions through the opening 50 of the ion channel 48 and deactivating the neuron, as seen in FIG. 3A. The cells are exposed to 488 nm wavelength light 16 to detect the intensity of fluorescence change due to the change of intracellular calcium ion concentration indicating the activity of the individual cells.

Although one scheme is shown in FIG. 3A and FIG. 3B to illustrate the types of schemes that can be employed, other photosensitive switches and channels can be used. Another example of a photosensitive switching scheme using similar principles is a light activated potassium channel.

The light activated potassium channel is similar in principle to the light-activated ionotropic glutamate receptor (LiGluR) except that it is used for inhibition instead of activation of LiGluR. In this scheme, a tether molecule contains a light sensitive component such as azobenzene that changes trans/cis conformations when exposed to the different wavelengths of light. When the photoswitch is exposed to the 500 nm wavelength light, the azobenzene changes conformation and causes the tether molecule to block the potassium ion channel. When the photo-switch is exposed to the 380 nm wavelength light, the azobenzene changes to another conformation causing the potassium ion channel to open resulting in the inhibition of neuron activity.

Likewise, the photosensitive ion channels can be also be naturally occurring light sensitive channels or membrane proteins. For example, rhodopsin, Channelrhodopsin-2 (ChR2), Halorhodopsins (NpHR), Volvox Channelrhpdopsin-1 (VChR1) and others can be exploited using comparable schemes.

Rhodopsins, for example, are light sensitive membrane proteins that can act as transducers for secondary messages. Bacterial Rhodopsins are naturally photosensitive ion channels or pumps without the secondary messages, such as Channelrhodopsin-2 (ChR2), Halorhodopsins (NpHR), Volvox Channelrhpdopsin-1 (VChR1). All of these examples can also be used in place of the artificial channels identified above. The naturally photosensitive ion channels may be derived from bacteria and can be introduced to target neurons or other cells to make them photosensitive. One example is ChR2, which is a photosensitive cation channel that can be activated with the application of 470 nm light irradiation. VChR1 has similar properties and applications as ChR2 but works on a redshifted wavelength. NpHR is light activated Chlorine ion membrane pump, it can be used for schemes of neuron inhibition with 590 nm light irradiation.

Referring back to FIG. 2, the photo switch 46 is first introduced to the sample 26 to permit the control of activity in the sample. The sample 26 is then placed on the stage of an optical microscope. The positions of the cells are optionally mapped so that the light spot locations can be determined and decisions regarding which cells or groups of cells to stimulate can be made by the system control 38 programming or by the user.

Selective stimulation of cells with points or shapes of light from the digital mirror device 34 from the 380 nm light source 30 is controlled by system control 38 and the light points are directed through an optical lens 36 to illuminate the subject specimen at specific locations and durations.

Cellular activity of the exposed cells in the specimen is determined by the indicator scheme, in this case the 488 nm light source that causes Calcium dye fluorescence is used. Image sequences 40 generated by the system control computer 38 from images obtained from camera 42 can be synchronized with the light pulses from the opening light source 30 and the closing light source 32. Light activated proteins can be expressed or activated at specific locations within a cell, on specific cells or on groups of cells. Nerve impulse cascades through networks of connected cells can be elucidated with stimulation patterns of cells or groups of cells simultaneously, sequentially or individually. Functional connections of cellular networks can also be verified by the redundant stimulation of parts of the observed network of connections. Portions of the specimen can also be activated and other portions deactivated simultaneously.

Three-dimensional stimulation schemes for larger sample volumes can be constructed and operated under the same principles with one or two additional planar DMD 34 panels fixed at designed angles to the sample volume and to each other. The system control 38 can program the mirrors of each DMD to project light points to locations in the x, y and z planes.

Although the system is illustrated with an optical platform for cell culture or tissue applications, the system can be applied to animal models such as Caenorhabditis elegans, zebrafish, and rats. Further adaptations of the system include in vivo remote optical control or study of animal neural networks and brain cortex studies. Mapping of human brain and nerve networks can lead to clinical applications to treat diseases related to the nervous system. The system and mapping results may also have application in computer science leading to contributions to the artificial neural network theory or artificial intelligence algorithms.

Those of skill in the art will appreciate how many aspects of the foregoing embodiments apply to a broad variety of alternative applications.

The invention may be better understood with reference to the accompanying examples, which are intended for purposes of illustration only and should not be construed as in any sense as limiting the scope of the present invention as defined in the claims appended hereto.

### Example 1

In order to demonstrate the system and method of use, the embodiment shown in FIG. 1 was used with fluorescent calcium indicator dyes to monitor neural activity and synaptic transmission in cultured rat hippocampal neurons.

As shown in the system configuration illustrated in FIG. 2 and FIG. 3, cells were transfected with iGluR6 and chemically modified with the chemical photoswitch MAG (Maleimide-Azobenzene-Glutamate) to generate the light-activated ionotropic glutamate receptor (LiGluR) and loaded with calcium dye (Fluo-4) and were placed on the stage of the optical microscope 24. There were two light emitting diodes (LED's) that were used as light sources 30, 32 with center wavelengths at 380 nm and 505 nm that were used to switch on and off LiGluR channels that were expressed in cultured postnatal hippocampal neurons, following attachment of the MAG photoswitch and loading of the Fluo-4 calcium dye 44. The two light emitting diodes 30, 32 with different wavelengths served as sources of illumination of a Digital Micromirror Device (DMD) 34, which projected spatially designed patterns of the light through an objective lens onto selected cells within the field.

Illumination at 380 nm, switches MAG from its trans isomer to the cis isomer, and activates the channel, while illumination at 505 nm triggers the opposite isomerization and deactivates the channel as seen in FIG. 3A and FIG. 3B. The 380 nm and 505 nm LED's were coupled to the system and combined into the same beam path. The design makes it possible to modulate light at the two wavelengths using the same Digital Micromirror Device (DMD) 34, thus avoiding a problem of registry of the fine patterns of the two wavelengths of light. The patterned light was projected onto cell cultures using a 20× objective 36 in an optical microscope. The optical addressable area on the sample was 0.87 mm×0.65 mm with a spatial resolution of 0.85 um (this can be adjusted by using different reduction objective lenses).

The measured output power density on the sample plane after the objective lens was adjusted up to 2 mW/mm². The Fluo-4 calcium dye was excited with a separate light source at 488 nm and emission was imaged following a bandpass filter centered at 530 nm and collected through a charge-coupled device (CCD) camera 42. The observed illumination intensity for calcium imaging was low (approximately tens of microwatts per square millimeter) to minimize any effect on LiGluR.

Initial experiments imaged the distribution and geometry of the rat hippocampal cells. Optical patterns were then designed to selectively stimulate specific cells, and these were displayed by the DMD and projected onto the cells through the objective lens.

Preceding and following the optical stimulation at the activating and deactivating wavelengths, fluorescence images of the Fluo-4 signal were acquired from the entire field of cells and were analyzed in real time. The system was shown to be capable of spatiotemporal modulation of the light stimulation patterns with switching times as short as milliseconds and with a submicron resolution within a projection area of approximately one millimeter.

### Example 2

In order to demonstrate the system and method of use on other cell types, Human Embryonic Kidney (HEK293) cells were studied using the system and apparatus shown in FIG. 2 and FIG. 3. The HEK293 cell line was used as a model to examine the fidelity and accuracy of the parallel optical stimulation and detection method. Like neurons, HEK293 cells expressing iGluR6 and labeled with MAG respond to optical stimulation in a manner that can be detected both electrophysiologically and via calcium imaging. However, the responses are less complex because the cells are not excitable, have no synaptic connections, and exhibit only passive responses.

The transfection rate of HEK293 cells was shown to be about thirty percent. Successfully transfected light-sensitive cells were identified by optical screening where cultures in the entire view field were alternately flood exposed to 380 nm and 505 nm light to open and close LiGluR, respectively, transiently allowing calcium to flux into the cell via the open channel leading to an increase in observed Fluo-4 fluorescence. As shown in FIGS. 3A and 3B, illumination at 380 nm opens the LiGluR channels and illumination at 505 nm closes them, thereby exciting the cells or turning the excitation stimulus off, respectively. The image sequences displayed by the DMD were synchronized with light pulses from the LEDs. Activation of the cells, detected by Fluo-4 (illuminated at 488 nm) due to calcium entering the excited cells, was imaged using a CCD 42.

A variety of optical illumination patterns were designed for selectively stimulating small groups of light sensitive cells (around 10 cells on average per frame). By synchronizing LED illumination, DMD pattern formation, and CCD imaging, the designed image frames 40 were displayed on the DMD 34, and each exposure pattern was alternately applied at 380 nm and 505 nm light before and after acquiring Fluo-4 images from the entire field.

Optical addressing with high accuracy and fidelity was demonstrated over multiple repeats of the different illumination patterns. Various exposure patterns displayed via the DMD 34 and the corresponding images of Fluo-4 intensity changes demonstrated that significant fluorescence changes can be observed only in cells which were optically excited.

Successful stimulation was shown 98.8% of the time, representing a high degree of spatial accuracy. The responses of three individual cells exposed to different temporal patterns of light over the course of 33 cycles were examined. Large increases in Fluo-4 fluorescence precisely correlated to cycles that included optical stimulation with 380 nm light.

The results shown in Example 1 and Example 2, illustrate that parallel optical stimulation can be achieved with high fidelity and spatial accuracy on HEK cells and cultured rat hippocampal neurons. The optical stimulation system can selectively elicit activity in target neurons within a simple neural network in a non-invasive manner. The ability to optically stimulate and detect neural activity using a device that can address multiple cells simultaneously is a significant advance over current techniques for investigating neural circuits.

It can be seen that the optical methods can be used with naturally occurring or engineered light-sensitive proteins whose expression can be targeted to desired specific cell types, or caged proteins or compounds, and can be activated in parallel at selective multiple sites around a cell, or at multiple cells in any desired spatiotemporal modulated manner. The apparatus has the ability to rapidly switch between multiple wavelengths and illumination patterns in milliseconds. The micron-scale spatial precision of the system can potentially be used to study responses to sub-cellular stimulation, while the ability to precisely stimulate multiple cells within neural circuits is well suited to the study and control of circuits within living animals.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for probing and manipulating complex biological systems, comprising:
a spatiotemporal illumination source configured to direct pinpoints and patterns of light at a selected wavelength on cells or groups of cells in a sample;
a cellular activity detector; and
a controller, operatively coupled to said spatiotemporal illumination source and said cellular activity detector,
wherein specific cellular activities of said sample in response to exposure to patterns of light of selected wavelengths are detected,
wherein said controller determines the location, time and wavelength of pinpoints or patterns of light from said spatiotemporal illumination source on said sample.

2. An apparatus as recited in claim 1, further comprising a lens system associated with said spatiotemporal illumination source, wherein said points and patterns of light from said illumination source are projected through said lens system to selected locations on said sample.

3. An apparatus as recited in claim 1, wherein said lens system is selected from the group of lens systems consisting essentially of a microscope, a projection lens or an objective lens.

4. An apparatus as recited in claim 1, wherein said spatiotemporal illumination source is configured to illuminate said specimen in three dimensional space.

5. An apparatus as recited in claim 1, wherein said controller is configured to obtain data from said cellular activity detector, analyze the data and generate illumination patterns directed to said sample through said spatiotemporal illumination source.

6. An apparatus as recited in claim 1, wherein said spatiotemporal illumination source is selected from the group of sources consisting essentially of one or more of a shutter, a mechanical shutter, an electronic shutter, a liquid crystal shutter, a chopper, a rotation wheel, an electric pulse power source, an Acousto-Optic Modulator, an Electro-Optic Modulator, a digital mirror device, a liquid crystal display, an Acousto-Optic Modulator, and Scanning mirrors with shutters or choppers.

7. An apparatus as recited in claim 1, wherein said wavelengths of said light patterns are selected to activate and deactivate photosensitive chemical switches in said sample.

8. An apparatus as recited in claim 7, wherein said photosensitive chemical switch opens or closes an ion channel with exposure to light patterns from said spatiotemporal illumination source.

9. A system, comprising:
a light source having an output of one or more light frequencies;
a spatiotemporal light modulator optically coupled to said output of said light source; and
a system control unit operatively coupled to said light source and said light modulator;
said light modulator having an output configured for optical coupling to a lens system;
said lens system configured for directing modulated light from said light source and said light modulator to a sample;
said system control unit configured for acquiring sample information in response to exposure of said sample to said modulated light.

10. A system as recited in claim 9, wherein said lens system is a lens system selected from the group consisting essentially of a microscope, a projection lens or an objective lens.

11. A system as recited in claim 9, wherein said light source is selected from the group of light sources consisting essentially of one or more of a lamp, a light emitting diode, a laser, a light emitting device, a halogen lamp, a mercury lamp, a xenon lamp, an LED of any available wavelength, or a laser of any available wavelength.

12. A system as recited in claim 9, wherein said spatiotemporal light modulator is selected from the group of modulators consisting essentially of one or more of a shutter, a mechanical shutter, an electronic shutter, a liquid crystal shutter, a chopper, a rotation wheel, an electric pulse power source, an Acousto-Optic Modulator, an Electro-Optic Modulator, a digital mirror device, a liquid crystal display, an Acousto-Optic Modulator, and Scanning mirrors with shutters or choppers.

13. A system as recited in claim 9, further comprising a wavelength modulator integrated with said spatiotemporal light modulator.

14. A system as recited in claim 13, wherein said wavelength modulator is selected from the group consisting essentially of one or more filters at various wavelength bands, a plurality of different color light emitting diodes or a plurality of different color lasers.

15. A system as recited in claim 9, further comprising an optical pathway from said light source to said spatiotemporal light modulator.

16. A system as recited in claim 15, further comprising an optical pathway from said lens system to said sample.

17. A system as recited in claim 9, wherein said system control unit is configured to capture signals from the sample, analyze said signals, generate pattern serials for spatiotemporal modulation, and control spatiotemporal and wavelength modulated pattern serials directed to said sample.

18. A system as recited in claim 17, wherein said signals are selected from the group of signals consisting essentially of one or more optical signals, electrical signals, topological signals, thermal signals, chemical signals, fluorescence signals, spectrum, light intensity, polarity, lifetime, intensity, Fluorescence Resonance Energy Transfer, ion concentration indicators, membrane potential indicators, or visual signals.

19. A system, comprising:
a plurality of light sources having an output of light frequencies;
a spatiotemporal light modulator optically coupled to said output of said plurality of light sources;
a system control unit operatively coupled to said light sources and said light modulator;
said light modulator having an output configured for optical coupling to a lens system;
said lens system configured for directing modulated light from said light source and said light modulator to a sample; and
a sample activity detector operatively coupled with said system control unit,
said system control unit configured for acquiring sample information in response to exposure of said sample to said modulated light.

20. A system as recited in claim 19, wherein said sample activity detector produces digital images and said system control unit creates a series of images and computes exposure patterns and frequencies of light from said spatiotemporal light modulator from said series of images.
